(19) United States
(12) Patent Application Publication
(10) Pub. No.: US 2010/0194574 A1
(43) Pub. Date: Aug. 5, 2010

(54) PARTICLE DETECTION SYSTEM AND METHOD OF DETECTING PARTICLES

(76) Inventors: David James Monk, Rexford, NY (US); Michael Joseph O'Brien, Clifton Park, NY (US); Andrew Michael Leach, Clifton Park, NY (US); Juntao Wu, Niskayuna, NY (US); Rui Chen, Clifton Park, NY (US); Boon Kwee Lee, Clifton Park, NY (US); Sergei Dolinsky, Clifton Park, NY (US); Weizhong Yan, Clifton Park, NY (US); Jan Abraham Braam, West Bradenton, FL (US); Jeffery Glenn Van Keuren, Bradenton, FL (US)

Correspondence Address: PATRICK W. RASCHE (22697);ARMSTRONG TEASDALE LLP, ONE METROPOLITAN SQUARE, SUITE 2600, ST. LOUIS, MO, 63102-2740, US

(21) Appl. No.: 12/362,674

(22) Filed: Jan. 30, 2009

(51) Int. Cl. G08B 21/00

(52) U.S. Cl. 340/627

(57) ABSTRACT

A method for detecting an aerosol plume includes emitting a light beam from a light source, the light beam having at least one light pulse, wherein the light pulse having a pulse width of between about 10 picoseconds (ps) and about 75 nanoseconds (ns), detecting backscattered light produced by the at least one light pulse interacting with particles in the aerosol plume, determining a presence of the aerosol plume based on the detected backscattered light, and outputting a signal indicating the presence of the aerosol plume.

### BACKGROUND OF THE INVENTION

1. Field of the Invention

The embodiments described herein relate generally to a particle detection system and, more particularly, to a particle detection system that detects aerosols, for example, aerosols produced during pyrolysis and/or combustion.

2. Description of the Related Art

At least some known smoke detectors rely on passive transport of aerosols for fire detection. More specifically, such smoke detectors only detect smoke particles once the smoke particles have been transported to the smoke detector. At least some other known smoke detectors actively transport particles into the detector to detect smoke. At least some known active smoke detectors are Very Early Smoke Detection Apparatus (VESDA) or High Sensitivity Smoke Detectors (HSSDs), which are configured to detect aerosols generated by pyrolyzing materials. However, both VESDAs and HSSDs are aspirating smoke detection systems that pump and filter air to determine the presence of aerosols generated by pyrolyzing materials. For example, aspirating smoke detectors continuously draw air into the detector and filter large particles, such as dust, from the air. Small particles in the air are directed to a detection chamber within the smoke detector, and light scatter caused by smoke is measured. A measurement signal is processed and the results are communicated to a user and/or a suitable component. An aspirating smoke detector can detect very small amounts of smoke and has a high sensitivity. However, such smoke detectors may be costly to install and/or maintain because such detectors include ducting.

At least some known smoke/fire detectors use optics, ionization, and/or combined smoke and heat. Optical smoke/fire detectors are more suited to detecting a slow burning fire that gives off larger smoke particles. Ionization smoke/fire detectors detect a quick burning fire that generates more heat and thinner smoke particles. Ionization technology may be combined with optics and/or heat detection as one type of combined smoke/fire detector. At least some known combined detectors detect both heat and smoke. However, each of these types of smoke/fire detectors are limited by the concentration of particles produced during pyrolysis and/or the time for transporting such particles to the detector.

Another type of known smoke/fire detector is a beam detector. The beam detector emits a light beam that can be 100 meters (m) in length and can cover 1500 square meters (m²) with a single unit. When the light beam is obscured by smoke (obscuration) by more than a certain percentage of obscuration, the beam detector activates an alarm. Such beam detectors can include a wall-mounted transmitter and a wall-mounted receiver at the other end of the building to detect the light beam. Alternatively, some beam detectors include a reflective plate which reflects the light beam back to the transmitter. However, such beam detectors can only detect particles once a cloud of particles reaches a density sufficient to obscure the light beam by more than a certain percentage, and once detected, such beam detectors cannot determine a location of the particles in the room. Further, such beam detectors, and other known types of smoke/fire detectors, cannot discriminate between particle clouds emitted during combustion and particle clouds emitted from a nuisance, such as a dust cloud. As used herein, the term “nuisance,” “nuisance cloud,” and/or “nuisance particle cloud” refers to an aerosol and/or a group of air-born particles that are not caused by an unknown source of a pyrolysis and/or combustion aerosol plume and/or particle cloud. For example, a nuisance cloud may be a dust cloud, fumes from a known source, and/or smoke from a known source.

Accordingly, there is a need for a smoke detector that can detect aerosols produced during pre-pyrolysis/pyrolysis without using an active transport method of particles into the detector and/or relying on passive transport of the particles to the detector. Further, there is a need for a smoke detector that can discriminate between aerosols from pre-pyrolysis/pyrolysis and particle clouds produced by a nuisance. Moreover, there is a need for a smoke detector that operates without use of separate transmitters and receivers and/or a mirror to reflect a light beam back to the source.

### BRIEF SUMMARY OF THE INVENTION

In one aspect, a method for detecting an aerosol plume is provided. The method includes emitting a light beam from a light source, the light beam having at least one light pulse, wherein the light pulse having a pulse width of between about 10 picoseconds (ps) and about 75 nanoseconds (ns), detecting backscattered light produced by the at least one light pulse interacting with particles in the aerosol plume, determining a presence of the aerosol plume based on the detected backscattered light, and outputting a signal indicating the presence of the aerosol plume.

In another aspect, a detection device for detecting an aerosol plume is provided. The detection device includes a light source configured to emit a light beam having a pulse width of between about 10 picoseconds (ps) and about 75 nanoseconds (ns), a detector configured to detect backscattered light generated by said light beam interacting with particles within the aerosol plume, and an electronics module in communication with the light source and the detector. The electronics module is configured to detect the aerosol plume using a signal intensity generated by the detector when detecting the backscattered light.

In yet another aspect, a particle detection system is provided. The particle detection system includes at least one unit positioned within a room and configured to detect an aerosol plume. The at least one unit includes a housing and at least one detection device coupled within the housing. The at least one detection device includes a light source configured to emit a light beam having a pulse width of between about 10 picoseconds (ps) and about 75 nanoseconds (ns), a detector configured to detect backscattered light generated by the light beam interacting with particles within the aerosol plume, and an electronics module in communication with the light source and the detector. The electronics module is configured to detect the aerosol plume using a signal intensity generated by the detector when detecting the backscattered light.

The embodiments described herein utilize LIDAR (LIght Detection And Ranging) for pyrolysis aerosol detection to enable earlier detection of combustion than known passive particle detection systems, and without the need to pump and filter air, as in active particle detection systems. Further, the embodiments described herein enable discrimination between pyrolysis aerosol plumes and nuisance particle clouds.

### BRIEF DESCRIPTION OF THE DRAWINGS

FIGS. 1-10 show exemplary embodiments of the systems and method described herein.

FIG. 1 shows an exemplary particle detection system.

FIG. 2 is an enlarged schematic illustration of a portion of the particle detection system shown in FIG. 1.

FIG. 3 is a schematic illustration of exemplary virtual detector zones that may be used with the particle detection system shown in FIG. 1.

FIG. 4 is a graph of exemplary signals for multiple zones shown in FIG. 3.

FIG. 5 is a flowchart of an exemplary method for detecting an aerosol plume that may be used with the particle detection system shown in FIG. 1.

FIG. 6 is a schematic view of an exemplary detection device that may be used with the particle detection system shown in FIG. 1.

FIG. 7 is a schematic view of an alternative detection device that may be used with the particle detection system shown in FIG. 1.

FIG. 8 is a schematic view of the particle detection system and aerosol plume shown in FIG. 1.

FIG. 9 is a schematic view of the particle detection system shown in FIG. 1 responding to the aerosol plume shown in FIG. 8.

FIG. 10 is a graph of exemplary test results comparing the particle detection system shown in FIG. 1 to a beam detection device.

### DETAILED DESCRIPTION OF THE INVENTION

The embodiments described herein use high spatial resolution LIght Detection And Ranging (LIDAR) for early detection of aerosol plumes produced by events, such as the pyrolysis and/or combustion of combustible materials. As used herein, the term “pyrolysis” refers to a chemical decomposition induced in organic materials by heat in an environment substantially free of oxygen. Pyrolysis creates a plume of particles/particulates, or an aerosol plume, before combustion begins. As such, the aerosol plume generated through pyrolysis includes pre-combustion gases rather than combustion gases, such as smoke. During pre-pyrolysis/pyrolysis there is generally insufficient energy to decompose a base material, additive/oligomer gases are produced near a heat source, and gases condense into particulates (aerosols) at room temperatures. As used herein, the term “oligomer” refers to a compound intermediate between a monomer and a polymer, normally having a relative small number of structural units. Aerosols that are produced during early stages of pyrolysis may form high molecular weight, semi-volatile, organic compounds. Such particulates may not be transported throughout a room and/or space during pre-pyrolysis/pyrolysis.

The systems described herein use nanosecond to sub-nanosecond resolving components to enable short distance, for example, less than 1.5 meter (m), detection of aerosol plumes. The embodiments described herein use multiple light wavelengths for the determination of particle size distribution of the aerosol plume and utilize triangulation using multiple sensors, or a single sensor operating in a sweep across a space, for three dimensional plume identification and tracking. As used herein, the term “size” refers to dimensions, a volume, and/or an area of a particle and/or an object, such as a particle cloud.

Further, the systems described herein detect elastic scattering, such as Mie scattering and/or Rayleigh scattering, from particles and/or molecules within an aerosol plume. More specifically, when light encounters an aerosol particle, the light is scattered elastically by a process known as Mie scattering. Most of the light is scattered forward, however, a portion of the light is scattered substantially backward. By using high spatial resolution LIDAR, with laser pulse widths of nanoseconds to sub-nanoseconds, light transmitted through an aerosol plume will result in backscatter of some of the transmitted light. The backscattered light will reach a detector within the particle detection system described herein and, by measuring the time between pulse initiation and backscatter, the distance between the detector and the aerosol plume can be determined. Plume size can also be determined using the embodiments described herein. Further, the use of multiple LIDAR sensors, or a sensor with a sweeping field of vision, enables three-dimensional mapping of aerosol plumes. The use of multiple wavelengths of light enables particle size distribution determination, as Mie scattering only occurs at wavelengths near, or less than, the size of the aerosol particle.

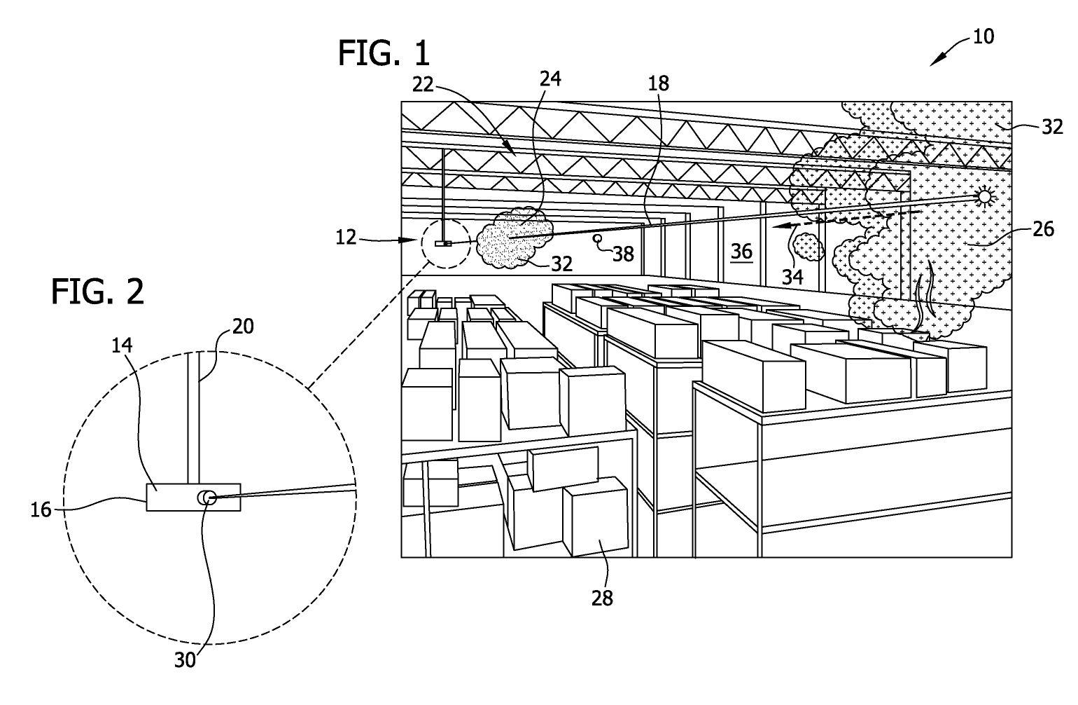

FIG. 1 shows an exemplary particle detection system 10. FIG. 2 shows an enlarged schematic illustration of a portion of particle detection system 10. Particle detection system 10 can be used in commercial, industrial, and/or residential settings. In one embodiment, particle detection system 10 is suitable for use as a smoke detector and/or a fire detector in commercial, industrial, and/or residential settings. Although particle detection system 10 is described herein as detecting particles, it will be understood that particle detection system 10 can detect particulates, molecules, and/or any other suitable gas-borne materials in addition to particles.

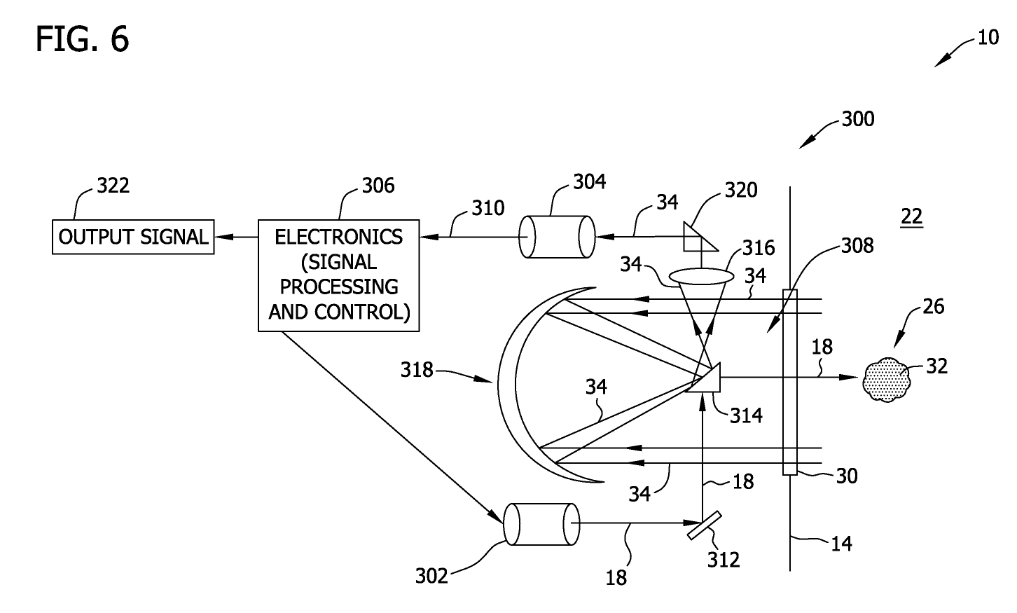

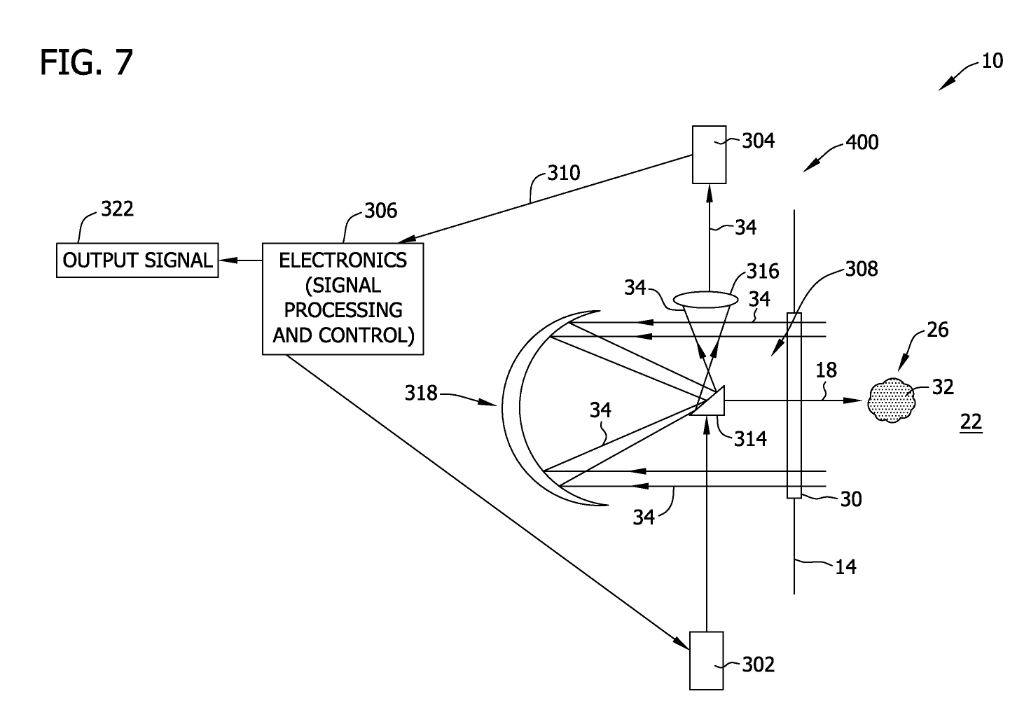

Particle detection system 10 includes at least one unit 12. Unit 12 includes a housing 14 having at least one detection device 300 (shown in FIG. 6) or at least one detection device 400 (shown in FIG. 7) therein. In the exemplary embodiment, detection device 300 and detection device 400 are high resolution LIDAR sensors. In one embodiment, housing 14 includes an array of detection devices 300 or 400 positioned with respect to an outer side wall 16 of housing 14. When housing 14 includes the array, a repetition rate of laser pulse can be selected to achieve a certain distance measured by particle detection system 10. For example, the maximum distance that can be measured may limit a measurement repetition frequency. In the exemplary embodiment, at least a portion of housing 14 adjacent detection device 300 or 400 is transparent to enable a light beam 18, such as a laser beam, emitted from detection device 300 or 400 to pass through housing 14. Further, housing 14 includes a mount 20 to mount housing 14 to a ceiling, as shown in FIG. 1, to a wall, or to any other suitable surface. In the exemplary embodiment, mount 20 enables housing 14 to rotate about mount 20 to direct light beam 18 in one or more desired directions. Alternatively, housing 14 is stationary with respect to mount 20.

In the exemplary embodiment, particle detection system 10 includes one unit 12 positioned in a room 22. As used herein, the term “room” refers to a partitioned part of an interior of a building, including the entire interior of the building. Alternatively, particle detection system 10 can include a plurality of units 12 within room 22. When the plurality of units 12 are positioned within room 22, each unit 12 can include one detection device 300 or 400 or an array of detection devices 300 or 400. When the plurality of units 12 are used, particle detection system 10 includes a network between detection devices 300 or 400 such that data from detection devices 300 or 400 is combined within a centralized control system. By combining data, particle detection system 10 can triangulate to determine a size of a particle cloud, such as a dust cloud 24 and/or an aerosol plume 26. Further, when the plurality of units 12 are included in particle detection system 10 the centralized control system can control units 12 to map and/or track aerosol plume 26 spatially and/or temporally. Such mapping and/or tracking of aerosol plume 26 can also be achieved using one unit 12 that is movable at least about mount 20.

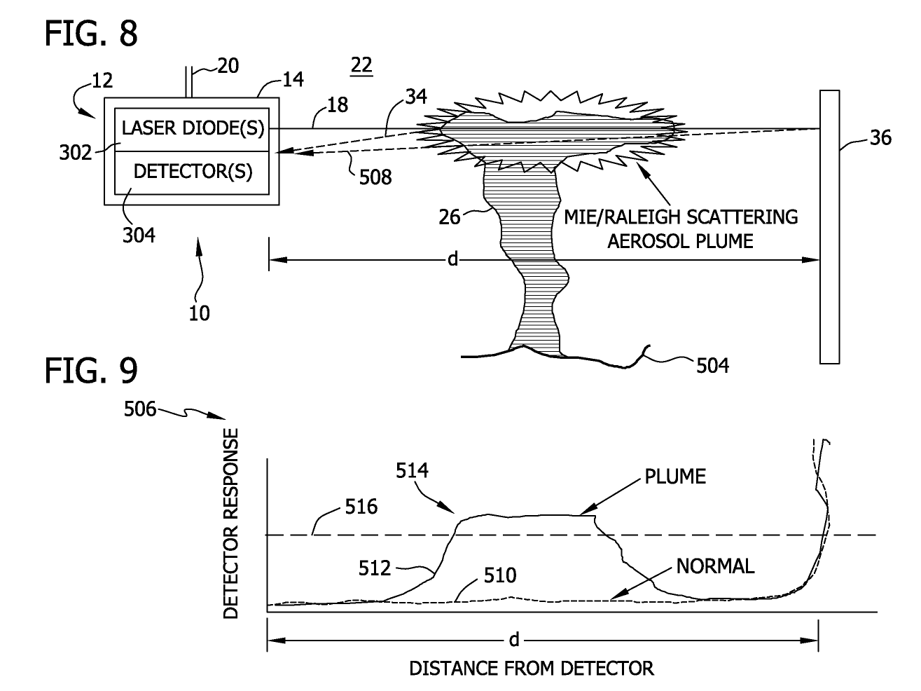

In the exemplary embodiment, aerosol plume 26 includes gas particles and/or particulates emitted during an early stage of pyrolysis. As such, aerosol plume 26 includes particles and/or particulates that are emitted before an object, such as a box 28 or a wire 504 (shown in FIG. 8), combusts. Detection device 300 or 400 is configured to detect particles and/or particulates within aerosol plume 26 using backscatter LIDAR for active detection. Further, detection device 300 or 400 is configured to detect a nuisance cloud, such as dust cloud 24, and determine that the nuisance cloud is not caused by pyrolysis. More specifically, as housing 14 rotates about mount 20, detection device 300 or 400 interrogates room 22 using light beam 18. Particle detection system 10 uses data collected by detection device 300 or 400 to determine whether a pyrolysis aerosol plume is present and/or to temporally and/or spatially map particulates for nuisance discrimination. Additionally, particle detection system 10 is configured to use LIDAR to determine characteristics, such as a location, a size, an intensity, a transmittance, and/or a temporal change, of a particle cloud.

In one embodiment, particle detection system 10 operates within a range of about 0.1% obscuration per foot to about 100% obscuration per foot. The term “obscuration,” as used herein, refers to a percentage of total light emitted from a light source that reaches a target, such as a receiver. For example, higher concentrations and/or densities of particles, such as smoke particles, between the light source and the target produce a higher percentage of obscuration. In the exemplary embodiment, particle detection system 10 detects Rayleigh scattering of light by molecules and Mie scattering of light by aerosols. When multiple wavelengths are emitted and/or detected, particle detection system 10 provides a particle size profile.

As described below with respect to FIGS. 8 and 9, particle detection system 10 is calibrated during initialization to substantially eliminate responses caused by known nuisances within room 22. Further, as particle detection system 10 operates, particle detection system 10 learns positions of other nuisances within room 22. In one embodiment, a threshold setpoint can be selected for learning by particle detection system 10. For example, a low threshold setpoint is selected for high value areas such that particle detection system 10 is more likely to determine that a particle cloud is an aerosol plume rather than a nuisance when the threshold setpoint is set to the low threshold setpoint as opposed to being set to a higher threshold setpoint.

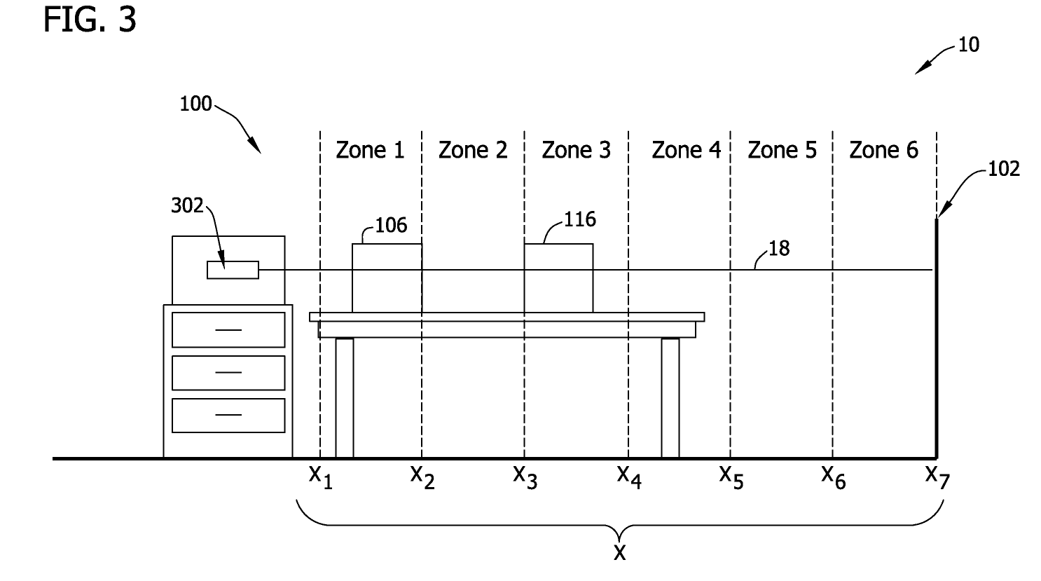

Further, particle detection system 10 is configured to enable a user to create a number of virtual smoke detectors or zones, as shown in FIG. 3. More specifically, FIG. 3 shows a cross-sectional slice of a grid of virtual zones defined within a room 100, such as room 22. In the exemplary embodiment, particle detection system 10 determines two reference points within a room 100. The first reference point is unit 12, an internal reflection, and/or a time when a pulse was triggered. The second reference point is any hard target, such as wall 102. Particle detection system 10 measures a distance, X, between the two reference points and scans room 100 to generate a two-dimensional (2D) map of room 100. Room 100 is segmented into virtual zones by particle detection system 10, based on a desired virtual zone size by, for example, setting subdivisions of distance X at points x₁, x₂, x₃, x₄, x₅, x₆, and x₇ in room 100.

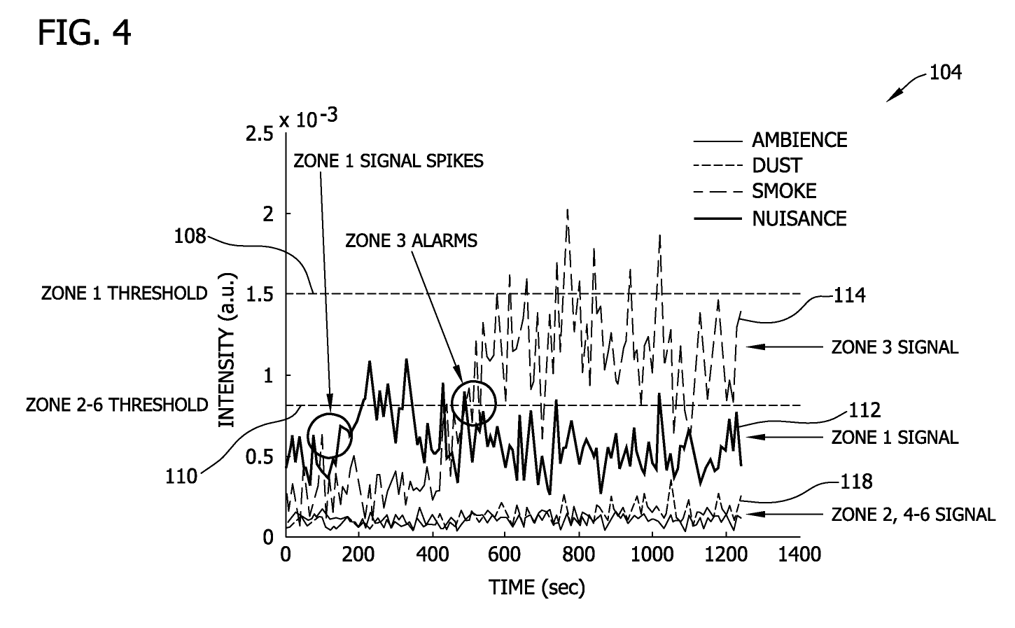

As shown in FIG. 3 and a graph 104 in FIG. 4, six zones are created and Zone 1 contains a known nuisance source 106. As such, Zone 1 has a higher threshold setpoint 108 than a threshold setpoint 110 in other zones. When particle detection system 10 generates response signals substantially simultaneously in two zones, for example, Zone 1 and Zone 3, particle detection system 10 determines that a response signal 112 corresponding to Zone 1 indicates the presence of a nuisance if response signal 112 is below threshold setpoint 108 for Zone 1. Particle detection system 10 determines that a response signal 114 corresponding to Zone 3 indicates the presence of an aerosol plume 116 if response signal 114 is higher than threshold setpoint 110 for Zone 3. In the example, Zone 3 signal is above threshold setpoint 110 and, as such, particle detection system 10 outputs a signal and/or an alarm that aerosol plume 26 and/or 116 is present and an action should be taken. In the example set forth above, response signals 118 corresponding to Zones 2 and 4-6 do not rise above an ambient response signal found empirically during initialization and/or calibration of particle detection system 10. In the exemplary embodiment, the ambient response is below threshold setpoint 110.

Further, referring to FIGS. 1 and 2, in alternative embodiments, particle detection system 10 includes a heat detector, a carbon monoxide (CO) detector, an integrated video and/or still camera, a motion sensing device, and/or any other suitable sensor and/or detection device that enables particle detection system 10 to detect an event occurring within room 22. Additionally, particle detection system 10 includes at least one conventional smoke/fire detector 38 positioned within room 22. Alternatively, particle detection system 10 does not include conventional smoke/fire detector 38. In the exemplary embodiment, LIDAR information acquired using detection device 300 or 400 is available for use to adjust a sensitivity of conventional smoke/fire detector 38. For example, if detection device 300 or 400 detects an aerosol plume suspected of being produced by a fire, the sensitivity of conventional smoke/fire detector 38 can be increased to corroborate the LIDAR data from detection device 300 or 400. Conversely, if detection device 300 or 400 detects a nuisance aerosol plume, such as steam, the sensitivity of conventional smoke/fire detector 38 can be decreased to avoid a false alarm from conventional smoke/fire detector 38.

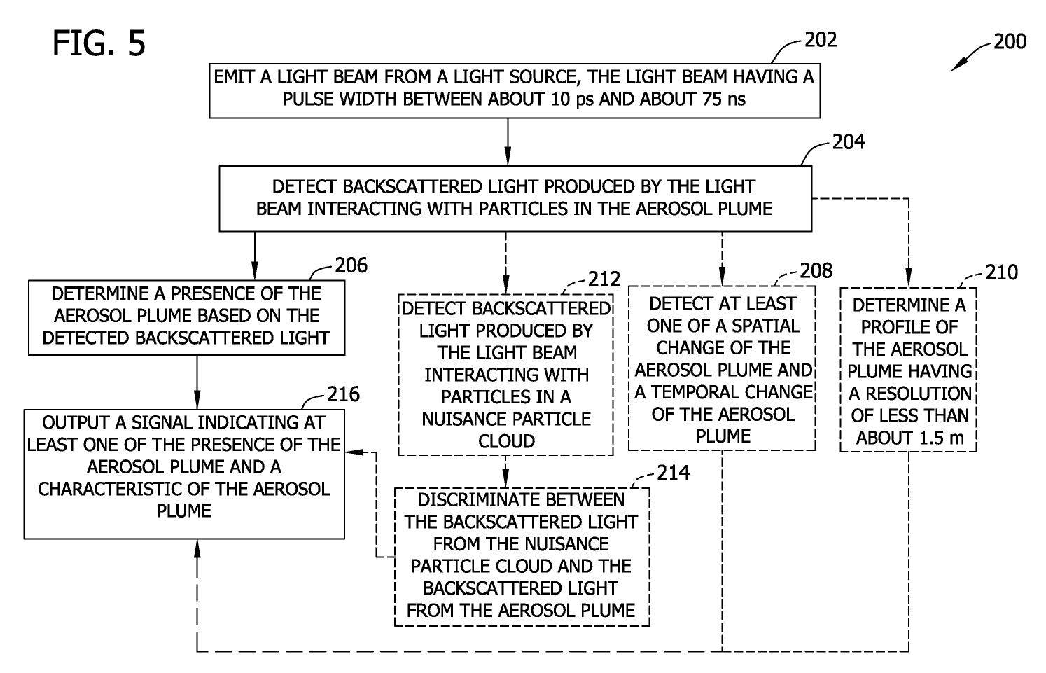

FIG. 5 is a flowchart of an exemplary method 200 for detecting aerosol plume 26 (shown in FIG. 1) that may be used with particle detection system 10 (shown in FIG. 1). Referring to FIGS. 1, 2, and 5, method 200 is performed by particle detection system 10 and/or a centralized control system (not shown). Method 200 includes emitting 202 light beam 18 from a light source, such as light source 302 (shown in FIGS. 5 and 6). More specifically, emitted light beam 18 has a pulse width of less than approximately 10 nanoseconds (ns). Such a pulse width provides a resolution of less than 1.5 meters (m) for objects and/or particle clouds within room 22. In a particular embodiment, beam 18 has a pulse width of between about 50 picoseconds (ps) and about 10 ns. In one embodiment, beam 18 has a pulse width of between about 10 picoseconds (ps) and about 75 ns. Further, although the exemplary embodiment does not have a pulse width within a femtosecond (fs) range, it will be understood that a pulse width within the femtosecond range can be used with particle detection system 10.

When light beam 18 interacts with particles in a particle cloud, at least a portion of light beam 18 is backscattered by about 180° with respect a direction of propagation of light beam 18. Particle detection system 10 detects 204 such backscattered light produced by light beam 18 interacting with particles within aerosol plume 26 produced during a pyrolysis stage of combustion of a material. In the exemplary embodiment, particle detection system 10 detects the backscattered light using a detector, such as detector 304 (shown in FIGS. 6 and 7).

Based on the detected backscattered light, particle detection system 10 determines 206 a presence of aerosol plume 26 within room 22. More specifically, based on an increase in intensity of electric signals generated from the detected backscattered light, particle detection system 10 determines 206 that aerosol plume 26 is present within room 22. In particular embodiments, particle detection system 10 also uses the detected backscattered light to detect 208 a spatial change of aerosol plume 26 and/or a temporal change of aerosol plume 26 and/or to determine 210 a profile, such as profile 514 (shown in FIG. 9), of aerosol plume 26, wherein the profile has a resolution of less than one foot. Such a high resolution is achieved by the sub-nanosecond pulse width of light beam 18.

Backscattered light is used to determine aerosol plume 26's location within room 22 because the backscatter intensity corresponds to a particulate concentration of aerosol plume 26. The backscatter intensity data with respect to distance and time data is used to generate a three-dimensional (3D) and/or a four-dimensional (4D) map of particle intensity within room 22. In one embodiment, a pulse activation time and a hard target reflection time are used, in addition to scanning, to obtain a two-dimensional (2D) image of at least a portion of room 22. Further, particle detection system 10 can include an algorithm that determines a change in a location of a hard target reflection, for example, something blocking the beam, and triggers an error. In the exemplary embodiment, the time data is analyzed to determine if a particle concentration at any point in room 22 is changing. As such, particle detection system 10 provides the capability to ignore parts of room 22, for example, by making an alarm threshold setpoint higher or lower. In one embodiment, if there is a high value area of room 22, it may be desirable to set a very low alarm threshold. On the other hand, if there is a known particle source in room 22, such as a cooking apparatus, it may be desirable to set the threshold higher.

In one embodiment, particle detection system 10 also detects 212 backscattered light produced by light beam 18 interacting with particles in a nuisance cloud, such as dust cloud 24. Particle detection system 10 discriminates 214 between the backscattered light from the nuisance cloud and the backscattered light from aerosol plume 26 to determine the presence of aerosol plume 26 and/or the nuisance cloud. More specifically, using a signal intensity of room 22 under normal conditions, particle detection system 10 can identify a known nuisance cloud and not alarm when such a nuisance cloud is detected. The signal intensity of room 22 under normal conditions can be based on calibration data and/or learned by particle detection system 10.

In the exemplary embodiment, particle detection system 10 outputs 216 a signal indicating the presence of aerosol plume 26 in room 22 and/or a characteristic of aerosol plume 26, such as spatial and/or temporal changes and/or the profile of aerosol plume 26. Particle detection system 10 outputs 216 any suitable alarm, message, notification, and/or signal based on a user's specifications and/or programming.

FIG. 6 is a schematic view of detection device 300 that may be used with particle detection system 10 (shown in FIG. 1). FIG. 7 is a schematic view of an alternative detection device 400 that may be used with particle detection system 10. Detection device 300 is a LIDAR sensor having a spatial resolution of less than about 1.5 m. In the exemplary embodiment, detection device 300 emits light beam 18 having a sub-nanosecond pulse width that produces a spatial resolution of about 1.5 m or less.

Detection device 300 includes a light source 302, a detector 304, electronics module 306, and optics components 308. Light source 302 and detector 304 are each in a generally 90° arrangement with respect to a transparent window 30, however, it will be understood that light source 302 and/or detector 304 may be in a generally 180° arrangement with respect to transparent window 30 and/or any other suitable arrangement. In FIG. 7, light source 302 and detector 304 are each in the 180° arrangement, otherwise detection device 300 and detection device 400 are essentially similar. Detection device 300 and/or detection device 400 are configured for high spatial resolution, i.e. less than 1.5 m resolution. Such high spatial resolution is achieved by increasing a frequency at which components of detection device 300 and/or 400 operate. Further, although, in the exemplary embodiment, detection device 300 has a coaxial arrangement, detection device 300 can have a biaxial arrangement and/or any other suitable arrangement.

In the exemplary embodiment, detection device 300 is positioned within housing 14 near a transparent window 30 and is configured to emit light beam 18 through transparent window 30 as a laser beam. Light beam 18 is emitted by light source 302 and focused by optics components 308. More specifically, light source 302 is configured to emit an eye-safe laser beam. In a particular embodiment, light source 302 includes a 905 nanometer (nm) laser diode or a 405 nm laser diode at a power that is between about 100 femto-Joules (fJ) and about 300 micro-Joules (μJ). Alternatively, light source 302 any suitable wavelength and/or power for generating a laser beam that enables particle detection system 10 to function as described herein. In the exemplary embodiment, and as discussed above with respect to FIG. 5, light beam 18 has a relatively small pulse width that is between less than about 10 ns. The pulse width can be selected to achieve a predetermined spatial resolution of particle detection system 10, such as a resolution less than about 1.5 m. Alternatively, light source 302 is a pulsed laser diode (PLD) or a pulsed light-emitting diode (LED).

In the exemplary embodiment, light source 302 is selected based on a configuration of detector 304. Factors considered when selecting light source 302 include: operating at an eye safe level, low power consumption, power output, polarization, Doppler shift LIDAR, differential absorption LIDAR (DIAL), megahertz (MHz) to kilohertz (kHz) repetition rate, Geiger mode operation versus analog mode operation, pulse width, multiple wavelengths, tunable wavelength laser source, cost, modulated continuous wave (CW) laser, laser bandwidth, jitter reduction, filters, collimation, laser coherence, size of light beam 18, size of light source 302, fiber laser versus diode laser, solid state, pulsed LED, and/or semiconductor LED. Any suitable light source that enables particle detection system 10 to function as described herein may be used as light source 302.

In the exemplary embodiment, detector 304 may include silicon (Si), which is sensitive to visible light, Indium gallium arsenide (InGaAs), which is sensitive to infrared (IR) light, and/or a vacuum photodetector. In one embodiment, a type and/or a configuration of light source 302 affects a type and/or a configuration of detector 304 used in detection device 300. Further, the type of detector 304 affects a type of signal 310 generated by detector 304 and/or a processing of signal 310 generated by detector 304. In certain embodiments, detector 304 includes one of: (1) a pin diode with analog signal measurement, which is used with a powerful laser source (nano-Joule (nJ) -μJ) but can perform measurements at low frequency (kilo-Hertz (kHz)-Hertz (Hz)); (2) an avalanche photodiode (APD) with analog signal measurement, which uses a fast speed analog-to-digital converter but can perform measurements at low frequency (kHz-Hz) and medium power laser (pico-Joule (pJ)-nJ); (3) a Geiger mode APD with digital measurement, which is used with a low power light source (pJ or less) to measure time to a first photon repeat at a high repetition rate (high kHz to mega-Hertz (MHz)) to construct an analog curve; and (4) an array of Geiger mode APDs with digital measurement, which is used with a low power light source (pJ or less) to measure time to an arrived photons repeat at a high repetition rate (high kHz to MHz) to construct an analog curve, wherein many measurements are performed simultaneously. In the exemplary embodiment, detector 304 is a Geiger mode APD array and/or any suitable APD.

Electronics module 306 is coupled in communication with at least light source 302 and detector 304. More specifically, electronics module 306 are configured to receive signal 310 from detector 304, to process signal 310, and to control light source 302. Electronics module 306 performs processing based on the type of detector 304 and/or the type of signal 310. In the exemplary embodiment, electronics module 306 includes a high speed data acquisition (DAQ) device or an oscilloscope. Further in the exemplary embodiment, electronics module 306 includes algorithms to perform method 200 (shown in FIG. 5). More specifically, electronics module 306 includes algorithms to determine a profile of aerosol plume 26 and/or dust cloud 24 (shown in FIG. 1), to discriminate particle sizes of particles 32 within dust cloud 24 and/or aerosol plume 26, to discriminate a nuisance cloud from aerosol plume 26, and to output an alarm based on the determination of the presence of aerosol plume 26. In a particular embodiment, electronics module 306 is configured to acquire spatial data, particle concentration data, and time data from within room 22 and generate a 4D map and/or a 3D map of particle concentration within room 22 from the acquired data.

In one embodiment, electronics module 306 includes an algorithm for testing and verification to account for build up on lenses, drift, aging, and/or any other characteristic effecting measurements of detection device 300. The testing/verification algorithm uses a reference point within room 22 or a reference chamber to perform GO/NOGO test methodology for testing a volumetric response in room 22. Such an algorithm may be a compensation algorithm for adjusting a response over a lifetime of detection device 300 and/or a verification algorithm that uses multiple detection devices 300 for validation of measurements. Additionally, electronics module 306 is coupled in communication with housing 14 and/or mount 20 (shown in FIG. 1) for controlling a rotation of housing 14 about mount 20. For example, electronics module 306 is configured to control a rotation rate of housing 14.

Other algorithms that may be programmed, implemented, and/or otherwise included in electronics module 306 include: overall power consumption algorithms; algorithms for monitoring battery power; processing algorithms for generating 2D and/or 3D maps of room 22; binning algorithms that enable the use time gating to step through slices of room 22; algorithms for operating in different operating modes and/or to switch from low power to high power; humidity and/or temperature variation compensation algorithms; algorithms to report by exception not under normal operation, for example, polling for a state and/or identifying devices that are present; algorithms for graded modes of operation, such as “shifting gears” between sensitivity levels and/or zooming in on a certain area in room 22, that can be user programmable for sensitivity; algorithms to use smart alarm verification, such as “alarm,” “clear,” “wait,” “turn on,” and/or “alarm again”; algorithms for normalization of electronics module 306; algorithms for changing gain levels; algorithms for operating in Geiger mode versus analog mode; calibration or training on installation algorithms, such as updating calibration via user control, user notification of an obstruction or a change in room parameters, and/or instantaneous versus gradual changes; algorithms for controlling an integrated mass notification system, such as a speaker and/or a strobe light; an algorithm for controlling mount 20 to direct light beam 18 in 2D or 3D space; and/or an algorithm for user adjustable spatial resolution, such as smart resolution mode for power-saving and/or zooming in on an area of interest.

In the exemplary embodiment, optics components 308 are configured to direct light beam 18 emitted from light source 302 toward aerosol plume 26 and to direct backscattered light 34 toward detector 304. In one embodiment, optics components 308 are BK7-based optics and include a first mirror 312, a prism or second mirror 314, a focusing lens and/or a filtering lens 316, a focusing mirror 318, and a third mirror 320. As shown in FIGS. 6 and 7, first mirror 312 and third mirror 320 are optional based on whether light source 302 and/or detector 304 is in the 90° arrangement or the 180° arrangement. In one embodiment, optics components 308 include micromirror arrays. Diameters and/or other dimensions of optics components 308 are selected to limit an amount of light emitted from detection device 300 and thereby limit a distance that can be measured by detection device 300. In the exemplary embodiment, optics components 308 are fabricated from IR transparent materials.

During operation, light source 302 emits light beam 18. In the exemplary embodiment, light beam 18 is a pulsed light beam with a sub-nanosecond pulse width. Light beam 18 is reflected by first mirror 312 to direct light beam 18 to second mirror 314. Second mirror 314 directs light beam 18 through transparent window 30 as a laser beam. Light beam 18 interacts with particles 32 of aerosol plume 26 or dust cloud 24. At least a portion of light beam 18 is backscattered by particles 32 to generate backscattered light 34. More specifically, backscattered light 34 includes light that is scattered about 180° with respect to a direction of propagation of light beam 18 through aerosol plume 26. Backscattered light 34 is directed through transparent window 30 to focusing mirror 318, which focuses backscattered light 34 to second mirror 314. Second mirror 314 directs backscattered light 34 to focusing lens and/or filtering lens 316. In the exemplary embodiment, focusing lens and/or filtering lens 316 removes background and/or ambient light from backscattered light 34 and directs backscatter light 34 to third mirror 320. Backscattered light 34 strikes third mirror 320 and is propagated toward detector 304.

Backscattered light 34 received by detector 304 is converted into signal 310 by converting photons to electrons. Signal 310 is processed by electronics module 306 to at least determine the presence of aerosol plume 26 within room 22. Electronics module 306 outputs a signal 322, such as an alarm and/or an electrical signal. For example, electronics module 306 outputs signal 322 if an action is required, such as when maintenance is required and/or an alarm event is occurring. In the exemplary embodiment, electronics module 306 outputs signal 322 if the presence of aerosol plume 26 is detected, as described in more detail with respect to FIGS. 5, 8, and 9. More specifically, the presence of aerosol plume 26 can indicate that a pre-combustion stage is occurring, and detection device 300 outputs signal 322 that combustion may occur within room 22 if an action is not taken. In one embodiment, electronics module 306 outputs signal 322 further indicating where in room 22 the pre-combustion stage is occurring and/or the size of aerosol plume 26.

FIG. 7 is a schematic view of detection device 400 that may be used with particle detection system 10 (shown in FIG. 1). Detection device 400 is a LIDAR sensor having a spatial resolution of less than one meter. In the exemplary embodiment, detection device 400 emits light beam 18 having a sub-nanosecond pulse width that produces a spatial resolution of about 1.5 m or less. Detection device 400 is substantially similar to detection device 300 (shown in FIG. 6) except detection device 400 does not include first mirror 312 (shown in FIG. 6) and third mirror 320 (shown in FIG. 5). As such, similar components are labeled with similar references. In the exemplary embodiment, light source 302 and detector 304 are each in the 180° arrangement rather than the 90° arrangement shown in FIG. 6. As such, light beam 18 is emitted from light source 302 toward second mirror 314, and backscattered light 34 is propagated from second mirror 314 toward detector 304 via lens 316.

FIG. 8 is a schematic view of particle detection system 10 (shown in FIG. 1) responding to aerosol plume 26. More specifically, FIG. 8 shows particle detection system 10 emitting light beam 18 through aerosol plume 26 produced from an overheating wire 504 within room 22. In FIG. 8, detection device 300 or 400 (shown in FIGS. 6 and 7) is spaced a distance d from a wall 36 of room 22. FIG. 9 shows a graph 506 of the response of particle detection system 10 along distance d measured between detection device 300 or 400 and wall 36 of room 22. Distance d shown in FIG. 9 substantially corresponds to distance d shown in FIG. 8. Graph 506 can be considered a profile of particles within room 22. As used herein, a profile of aerosol plume 26 is a 2D or 3D map of aerosol plume 26 within room 22 generated by plotting an intensity of a response signal with respect to a distance from detection device 300 or 400 within room 22.

In the exemplary embodiment, unit 12 emits light beam 18 across room 22 to wall 36 of room 22. Wall 36 backscatters at least a portion 508 of light beam 18. Accordingly, under normal circumstances, as shown by a normal curve 510 of graph 506, unit 12 does not generate a high response within room 22 except at wall 36. Normal curve 510 can be used to calibrate particle detection system 10 for nuisance discrimination. In one embodiment, when a nuisance is usually within room 22, normal curve 510 indicates an increase in the response signal corresponding to a location of the nuisance. In the exemplary embodiment, when aerosol plume 26 is present within room 22, aerosol plume 26 backscatters at least a portion 34 of light beam 18. Accordingly, particle detection system 10 produces a response signal that increases in intensity at a location corresponding to a location of aerosol plume 26. Such a response is shown in graph 506 as a plume curve 512. Plume curve 512 includes a profile 514 of aerosol plume 26. Plume curve 512 also includes the response signal generated by light 508 backscattered by wall 36.

Plume curve 512 deviates from normal curve 510 at a location corresponding to a location of aerosol plume 26 within room 22. Such a deviation can be measured by electronics module 306 (shown in FIGS. 6 and 7). When the deviation and/or signal intensity of plume curve 512 is greater than a threshold setpoint, such as setpoint 516, particle detection system 10 outputs an alarm and/or other suitable signal indicating the presence of aerosol plume 26.

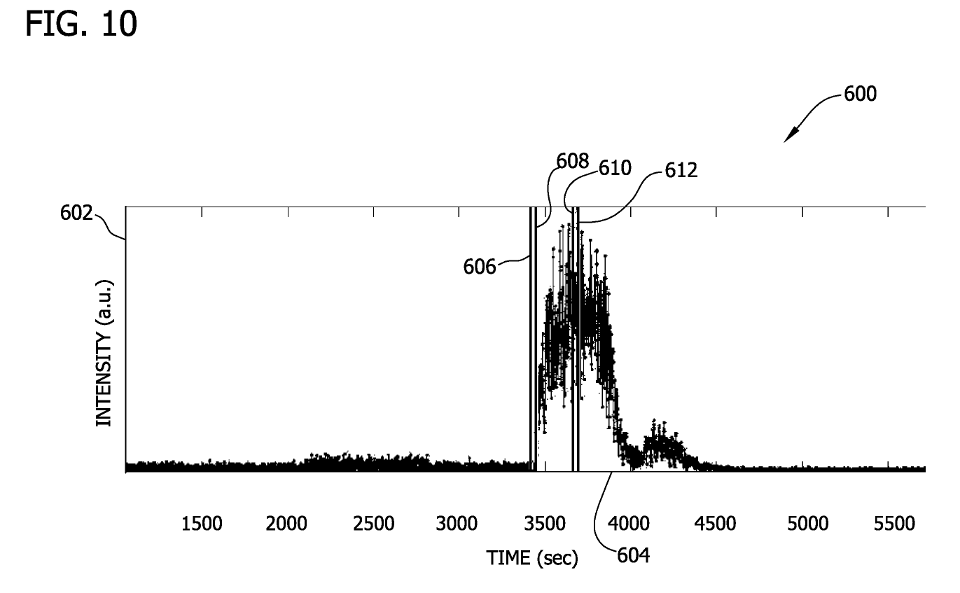

FIG. 10 is a graph 600 of exemplary test results comparing particle detection system 10 (shown in FIG. 1) to a beam detector, such as a known beam smoke detector. Graph 600 plots an intensity of signal response in arbitrary units (a.u.) along an Y-axis 602 with respect to time in seconds (sec) along a X-axis 604. Results shown on graph 600 were acquired during an experiment using a test fire of toluene and heptane to test responses of particle detection system 10 and a beam detector that alarms at 1.5% obscuration. Toluene and heptane are flammable liquids.

At a first time 606, combustion is initiated by heating the toluene and heptane. After first time 606, pre-pyrolysis/pyrolysis occurs before combustion occurs. At a second time 608 after first time 606, particle detection system 10 detects an aerosol plume produced by the toluene and heptane and outputs an alarm and/or signal. Second time 608 is less than one second after first time 606 in the example experiment. At a third time 610 after second time 608, combustion occurs. At a fourth time 612 after third time 610, the beam detector measures about 1.5% obscuration of a light beam emitted by the beam detector and outputs an alarm and/or signal. Accordingly, particle detection system 10 detects a pyrolysis stage of combustion before the beam detector does and before a fire occurs. Tests using newspaper and wood as combustion materials demonstrate similar results with particle detection system 10 detecting an initiated combustion before the beam detector does and before combustion occurs.

The embodiments described herein facilitate proactively detecting combustion rather than reactively detecting combustion. More specifically, known smoke/fire detectors detect combustion only after smoke has been produced by combustion. However, the embodiments described herein detect a pyrolysis stage of combustion before a fire occurs by detecting pyrolysis aerosol plumes. For example, the embodiments described herein can detect faulty wiring before any further property damage has occurred. In contrast, known smoke/fire detectors cannot sense a fire until smoke is drawn into the detector and/or reaches a predetermined density. As such, by the time a known smoke/fire detector detects a fire, property damage has already occurred. Further, the systems described herein can selectively and/or sensitively detect pyrolysis gases. More specifically, the above-described systems can detect a relatively small amount of pre-combustion particles as compared to the amount of smoke particles required to be detected by known smoke detectors and determined the difference between pyrolysis aerosols and a nuisance cloud.

Moreover, the embodiments described herein include components that are relatively easy to replace and/or upgrade as compared to known active smoke/fire detectors. More specifically, the embodiments described herein do not include air pumps, air filters, and/or other air flow components. As such, installation and/or operation of the above-described systems are simplified as compared to known smoke/fire detectors. Further, the embodiments described herein enable remote detection of aerosol plumes without mechanical movement of air into the sensor. By actively sensing aerosols, a significant decrease in the amount of time between aerosol generation and detection can occur for early detection of pyrolysis emissions. Additionally, by using a pulse width of between about 10 ps and about 75 ns, the resolution of the particle detection system and/or detection device is suitable for use within a room. More specifically, a pulse width of between about 10 ps and about 75 ns produces a resolution of less than about 1.5 m, however the pulse width can be adjusted based on the application in which the particle detection system is used.

A technical effect of the systems and method described herein includes at least one of: (a) emitting a light beam from a light source, the light beam having a pulse width of between about 10 picoseconds (ps) and about 75 nanoseconds (ns); (b) detecting backscattered light produced by the light beam interacting with particles in the aerosol plume, for example, an aerosol plume produced during a pyrolysis stage and/or a combustion stage of a material; (c) determining a presence of the aerosol plume based on the detected backscattered light; and (d) outputting a signal indicating at least one of the presence of the aerosol plume and a characteristic of the aerosol plume.

Exemplary embodiments of a particle detection system and a method of detecting particles are described above in detail. The method and system are not limited to the specific embodiments described herein, but rather, components of systems and/or steps of the methods may be utilized independently and separately from other components and/or steps described herein. For example, the methods may also be used in combination with other particle detection systems and methods, and are not limited to practice with only the pyrolysis particle detection systems and methods as described herein. Rather, the exemplary embodiment can be implemented and utilized in connection with many other particle detection applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for detecting an aerosol plume, said method comprising:
emitting a light beam from a light source, the light beam having at least one light pulse, the light pulse having a pulse width of between about 10 picoseconds (ps) and about 75 nanoseconds (ns);
detecting backscattered light produced by the at least one light pulse interacting with particles in the aerosol plume;
determining a presence of the aerosol plume based on the detected backscattered light; and
outputting a signal indicating the presence of the aerosol plume.

2. A method in accordance with claim 1, wherein detecting backscattered light further comprises detecting backscattered light produced by a light pulse interacting with particles in an aerosol plume produced during at least one of a pyrolysis stage and a combustion stage of a material.

3. A method in accordance with claim 2 further comprising:
detecting backscattered light produced by the light beam interacting with particles in a nuisance particle cloud; and
discriminating between the backscattered light from the nuisance particle cloud and the backscattered light from the aerosol plume.

4. A method in accordance with claim 1 further comprising detecting at least one of a spatial change of the aerosol plume and a temporal change of the aerosol plume.

5. A detection device for detecting an aerosol plume, said detection device comprising:
a light source configured to emit a light beam having a pulse width of between about 10 picoseconds (ps) and about 75 nanoseconds (ns);
a detector configured to detect backscattered light generated by said light beam interacting with particles within the aerosol plume; and
an electronics module in communication with said light source and said detector, said electronics module configured to detect the aerosol plume using a signal intensity generated by said detector when detecting the backscattered light.

6. A detection device in accordance with claim 5, wherein said detector is configured to detect an aerosol plume produced during at least one of a pyrolysis stage and a combustion stage of a material.

7. A detection device in accordance with claim 5, wherein said electronics module is configured to determine a distance of the aerosol plume from said detection device based on the backscattered light.

8. A detection device in accordance with claim 5, wherein said electronics module is configured to detect a size of the aerosol plume based on the backscattered light.

9. A detection device in accordance with claim 5, wherein said electronics module is configured to detect at least one of a spatial change of the aerosol plume and a temporal change of the aerosol plume.

10. A detection device in accordance with claim 5, wherein said electronics module is configured to detect a size of a particle within the aerosol plume based on the backscattered light.

11. A detection device in accordance with claim 5, wherein said light source is one of a pulsed laser beam source and a pulse light emitting diode.

12. A particle detection system comprising at least one unit positioned within a room and configured to detect an aerosol plume, said at least one unit comprising:
a housing; and
at least one detection device coupled within said housing, said at least one detection device comprising:
a light source configured to emit a light beam having a pulse width of between about 10 picoseconds (ps) and about 75 nanoseconds (ns);
a detector configured to detect backscattered light generated by the light beam interacting with particles within the aerosol plume; and
an electronics module in communication with said light source and said detector, said electronics module configured to detect the aerosol plume using a signal intensity generated by said detector when detecting the backscattered light.

13. A particle detection system in accordance with claim 12, wherein said at least one unit further comprises a plurality of detection devices coupled within said housing.

14. A particle detection system in accordance with claim 12 further comprising a plurality of units positioned within the room, said plurality of units configured to detect at least one of a spatial change in the aerosol plume and a temporal change in the aerosol plume.

15. A particle detection system in accordance with claim 12 further comprising a mount coupled to said housing, said housing rotatable about said mount, said electronics module coupled in communication with at least one of said mount and said housing, said electronic module configured to control a rotation of said housing with respect to said mount.

16. A particle detection system in accordance with claim 12, wherein said particle detection system is configured to:
segment the room into a plurality of virtual zones; and
substantially simultaneously monitor the plurality of virtual zones within the room for a presence of the aerosol plume.

17. A particle detection system in accordance with claim 16, wherein said particle detection system is configured to assign a threshold setpoint to each virtual zone of the plurality of virtual zones, the presence of the aerosol plume determined based on a location of the aerosol plume within the room and a threshold setpoint of a virtual zone corresponding to the location of the aerosol plume.

18. A particle detection system in accordance with claim 12, wherein said electronics module is configured to:
acquire spatial data, particle concentration data, and time data from within the room; and
generate a four-dimensional map of particle concentration within the room using the acquired data.

19. A particle detection system in accordance with claim 12 further comprising at least one of a heat detector, a carbon monoxide detector, an integrated video camera, a still camera, and a motion sensing device.

20. A particle detection system in accordance with claim 12, wherein said electronics module is configured to discriminate a nuisance particle cloud from an aerosol plume produced during at least one of a pyrolysis stage and a combustion stage of a material.

21. A particle detection system in accordance with claim 12 further comprising at least one smoke/fire detector positioned within the room, said particle detection system configured to adjust a sensitivity of said at least one smoke/fire detector based on LIght Detection and Ranging (LIDAR) data acquired by said at least one detection device.
